(19) United States
(12) Patent Application Publication
(10) Pub. No.: US 2024/0209985 A1
(43) Pub. Date: Jun. 27, 2024

(54) HIGH PRESSURE TANK AND METHOD FOR MANUFACTURING LINER

(71) Applicant: HONDA MOTOR CO., LTD., TOKYO (JP)

(72) Inventor: Kosuke TATSUSHIMA, WAKO-SHI (JP)

(21) Appl. No.: 18/391,915

(22) Filed: Dec. 21, 2023

(30) Foreign Application Priority Data
Dec. 27, 2022 (JP) 2022-210505

(51) Int. Cl. F17C 1/16; B29C 49/06; F17C 1/06

(52) U.S. Cl. CPC F17C 1/16; B29C 49/06; F17C 1/06; F17C 2201/0109; F17C 2203/0604; F17C 2205/0305

(57) ABSTRACT

A method for manufacturing a liner includes a shaft preparation step. In the shaft preparation step, a shaft assembly is prepared in which an annular shaped first attachment and an annular shaped second attachment are attached to the outer circumferential portion of a tubular shaped shaft including an air supply hole. The method for manufacturing the liner further includes a parison supply step of arranging the shaft assembly on an inner side of a parison, and a blow molding step of closing a mold device, supplying air into the parison from the air supply hole to thereby cause the parison to expand, and obtaining a liner molded body. The method for manufacturing the liner further includes a detachment step of removing the shaft from the first attachment and the second attachment, and taking out the shaft to the exterior of the liner molded body.

### CROSS-REFERENCE TO RELATED APPLICATIONS

This application is based upon and claims the benefit of priority from Japanese Patent Application No. 2022-210505 filed on Dec. 27, 2022, the contents of which are incorporated herein by reference.

### BACKGROUND OF THE INVENTION

### Field of the Invention

The present invention relates to a high pressure tank including a liner, and a method for manufacturing the liner.

### Description of the Related Art

A liner of a pressure container disclosed in JP 2016-150517 A is formed from a resin material, and is equipped with a body portion, and a pair of dome portions formed at both ends of the body portion. The pressure container is extrusion molded by way of a blow molding machine. At a time when the pressure container is manufactured, after a tubular shaped parison has been pushed out from the blow molding machine into the interior of a mold, air is supplied from a hole portion of a tubular shaped rod that is arranged in the interior of the parison. Cap members are arranged at both end parts of the tubular shaped rod. By the pressure of the air that is led out from the hole portion of the rod, the parison is pushed outward and pressed against an inner surface of the mold. Top parts of the pair of dome portions are formed coaxially with the rod, and the cap members and both end parts of the rod are retained on the dome portions.

### SUMMARY OF THE INVENTION

In the pressure container disclosed in JP 2016-150517 A, since the rod and the cap members that are used when blow molding the liner are retained on the pair of dome portions, the rod remains attached to the pressure container, and along therewith, the weight of the pressure container is increased by the weight of the rod.

A first aspect of the present invention is characterized by a manufacturing method for manufacturing a liner including a cylinder portion having a round tubular shape, a first dome portion disposed at one end part in an axial direction of the cylinder portion, and a second dome portion disposed at another end part in the axial direction of the cylinder portion, the manufacturing method comprising: a shaft preparation step, which is a shaft preparation step of preparing a shaft assembly in which a first attachment having an annular shape and a second attachment having an annular shape are attached to an outer circumferential portion of a shaft that has a tubular shape, includes an air supply hole, and extends in a straight line shape, wherein a first boss having an annular shape is attachable to the first attachment, a second boss having an annular shape is attachable to the second attachment, the first attachment and the second attachment are arranged to be separated apart from each other in an axial direction of the shaft, and the shaft is removable from the first attachment and the second attachment; a parison supply step of supplying a parison having a tubular shape and made of a resin material toward a mold device configured to mold the liner, and arranging the shaft assembly on an inner side of the parison; a blow molding step of closing the mold device, supplying air into the parison from the air supply hole of the shaft to thereby cause the parison to expand, and obtaining a liner molded body in which the first attachment including a first hole portion is integrally molded on the first dome, and the second attachment including a second hole portion disposed concentrically with the first hole portion is integrally molded on the second dome; and a detachment step of removing the shaft from the first attachment and the second attachment after the blow molding step, and taking out the shaft to an exterior of the liner molded body.

According to this liner manufacturing method, in the blow molding step of molding the liner including the cylinder portion and the first and second dome portions, the first and second attachments are integrally molded on the first and second dome portions of the liner in a manner so that the first hole portion of the first attachment and the second hole portion of the second attachment become concentric, whereby at a time when the first boss is attached to the first attachment, and the second boss is attached to the second attachment, the degree of coaxiality between the first boss and the second boss can be ensured. After the liner molded body has been molded, the shaft can be removed in the axial direction from the first attachment and the second attachment of the shaft assembly, and therefore, compared to a configuration in which the shaft remains incorporated in the liner molded body, an unnecessary increase in the weight of the high pressure tank accompanying usage of the shaft can be avoided.

Between the blow molding step and the detachment step, there may be included a filament winding step of winding reinforcing fibers around an outer circumferential surface of the liner, and in the filament winding step, the liner molded body may be supported by the shaft, and the liner molded body may be rotated via the shaft.

According to this manufacturing method, in the filament winding step, the shaft can be used as a jig for fixing and causing the liner to rotate. Therefore, there is no need to separately prepare and attach a rotating jig, and the filament winding step can be performed efficiently.

An outer circumferential surface of the shaft may include a first male threaded portion and a second male threaded portion provided at different positions in the axial direction of the shaft, an inner circumferential surface of the first attachment may include a first female threaded portion configured to be screw engaged with the first male threaded portion, an inner circumferential surface of the second attachment may include a second female threaded portion configured to be screw engaged with the second male threaded portion, in the shaft assembly, the first male threaded portion and the first female threaded portion may be screw engaged with each other, and the second male threaded portion and the second female threaded portion may be screw engaged with each other, and in the detachment step, by causing the shaft to rotate relatively with respect to the liner molded body, screw engagement between the first male threaded portion and the first female threaded portion may be released, and screw engagement between the second male threaded portion and the second female threaded portion may be released.

According to this manufacturing method, in the detachment step, by causing the shaft to rotate relatively with respect to the liner molded body, the screw engagement between the first male threaded portion and the first female threaded portion is released, and the screw engagement between the second male threaded portion and the second female threaded portion is released. Therefore, the shaft can be easily removed from the liner molded body.

An inner diameter of the second attachment may be larger than an inner diameter of the first attachment, and in the detachment step, the shaft may be made to move relatively with respect to the liner molded body in a direction from the first attachment toward the second attachment.

According to this manufacturing method, in the detachment step, after the second male threaded portion of the shaft has been detached from the second female threaded portion of the second attachment, the first male threaded portion of the shaft can pass through the second female threaded portion of the second attachment without causing the shaft to rotate relatively with respect to the liner molded body. Therefore, the shaft can be easily taken out from the liner molded body.

The shaft may include a shaft main body extending in the axial direction of the shaft, a first retaining mechanism provided on the shaft main body, and configured to retain the first attachment in a detachable manner, and a second retaining mechanism provided on the shaft main body at a position separated apart from the first retaining mechanism in the axial direction of the shaft, and configured to retain the second attachment in a detachable manner, the first retaining mechanism may include a first locking member configured to be displaced in a radial direction of the shaft main body and project out from an outer circumferential surface of the shaft main body to lock the first attachment, and a first elastic member configured to bias the first locking member outwardly in the radial direction of the shaft main body, the second retaining mechanism may include a second locking member configured to be displaced in the radial direction of the shaft main body and project out from the outer circumferential surface of the shaft main body to lock the second attachment, and a second elastic member configured to bias the second locking member outwardly in the radial direction of the shaft main body, in the shaft preparation step, the first locking member and the second locking member may project out from the outer circumferential surface of the shaft main body, and the first and second attachments may engage with the shaft in the axial direction of the shaft, and in the detachment step, accompanying relative movement of the shaft in the axial direction thereof with respect to the liner molded body, the first attachment may cause the first locking member to be displaced inwardly in the radial direction of the shaft main body against a biasing force of the first elastic member, and the second attachment may cause the second locking member to be displaced inwardly in the radial direction of the shaft main body against a biasing force of the second elastic member, to thereby release engagement of the first and second attachments with the shaft in the axial direction of the shaft.

According to this manufacturing method, in the shaft preparation step, since relative movement of the shaft in the axial direction with respect to the first and second attachments is prevented by the first and second locking members which are biased outwardly in the radial direction and project out from the outer circumferential surface of the shaft main body, the first and second attachments can be stably fixed to the shaft. In the detachment step, the first and second locking members are accommodated inwardly in the radial direction from the outer circumferential surface against the elastic force, whereby it becomes possible for the shaft to move relatively in the axial direction with respect to the first and second attachments, and the shaft can be removed from the first and second attachments.

A second aspect of the present invention is characterized by a high pressure tank, comprising a liner made of a resin material and including a cylinder portion having a round tubular shape, a first dome portion having a curved shape and disposed at one end part in an axial direction of the cylinder portion, and a second dome portion having a curved shape and disposed at another end part in the axial direction of the cylinder portion, a first attachment that has an annular shape, is integrally molded with the first dome portion on an axial line of the cylinder portion, and includes a first hole portion penetrating in the axial direction of the cylinder portion, a second attachment that has an annular shape, is integrally molded with the second dome portion on the axial line of the cylinder portion, and includes a second hole portion penetrating in the axial direction of the cylinder portion and disposed concentrically with the first hole portion, a first boss having an annular shape and concentrically fixed to the first attachment, and a second boss having an annular shape and concentrically fixed to the second attachment.

According to this high pressure tank, the first and second attachments are integrally molded on the first and second dome portions of the liner. Therefore, at a time when the first boss is attached to the first attachment, and the second boss is attached to the second attachment, the degree of coaxiality between the first boss and the second boss can be ensured.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall cross-sectional view of a high pressure tank including a liner according to an embodiment of the present invention;

FIG. 2 is an enlarged cross-sectional view of a vicinity of a first attachment in the high-pressure tank shown in FIG. 1;

FIG. 3 is an enlarged cross-sectional view of a vicinity of a second attachment in the high-pressure tank shown in FIG. 1;

FIG. 4 is an external front view of the first and second attachments;

FIG. 5A is an enlarged cross-sectional view showing a vicinity of the first and second attachments according to a modification;

FIG. 5B is a cross-sectional view taken along line VB-VB of FIG. 5A;

FIG. 6 is an overall configuration diagram of a mold device showing a state in which a shaft assembly is set in a mold;

FIG. 7 is an overall cross-sectional view of the shaft assembly which is constituted from a shaft, and the first and second attachments;

FIG. 8 is an explanatory diagram showing a shaft preparation step for constructing a shaft assembly, and a parison supply step of supplying a parison into the mold of the mold device;

FIG. 9 is an explanatory diagram showing a step of closing the mold of the mold device shown in FIG. 8;

FIG. 10 is an explanatory diagram showing a blow molding step of a liner molded body in the mold device shown in FIG. 9;

FIG. 11 is an explanatory diagram showing a step of opening the mold and taking out the liner molded body;

FIG. 12 is an explanatory diagram showing a filament winding step of winding reinforcing fibers around an outer circumferential surface of the liner molded body;

FIG. 13 is an explanatory diagram showing a detachment step of taking out the shaft from the liner molded body;

FIG. 14A is an enlarged configuration diagram of a vicinity of the first and second attachments in the liner molded body;

FIG. 14B is an explanatory diagram of an operation at a time of removing the shaft from the first and second attachments of the liner molded body shown in FIG. 14A;

FIG. 15A is an enlarged configuration diagram of a vicinity of the first and second attachments according to a first modification;

FIG. 15B is an explanatory diagram of an operation at a time of removing the shaft from the first and second attachments shown in FIG. 15A;

FIG. 16A is an enlarged configuration diagram of a vicinity of first and second retaining mechanisms according to a second modification; and

FIG. 16B is an explanatory diagram of an operation at a time of removing the shaft from the first and second attachments in the first and second retaining mechanisms shown in FIG. 16A.

### DETAILED DESCRIPTION OF THE INVENTION

A high pressure tank 10 according to the present embodiment is used with the aim of storing hydrogen gas. Moreover, it should be noted that the gas that is stored in the high pressure tank 10 may be a gas other than hydrogen gas, for example, such as nitrogen gas or the like. The high pressure tank 10 is mounted on a fuel cell vehicle. The high pressure tank 10 stores the hydrogen gas which is supplied to a fuel cell system.

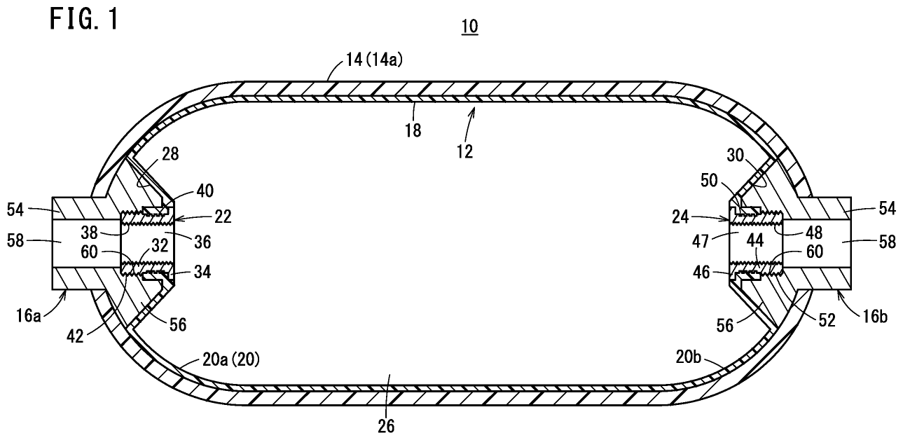

As shown in FIG. 1, the high pressure tank 10 according to the present embodiment is equipped with a liner 12, a reinforcing layer 14 provided on an outer circumferential surface of the liner 12, and first and second bosses 16a and 16b provided at axial end parts of the liner 12.

The liner 12 is a hollow body formed from a resin material. The liner 12 serves as an inner layer of the high pressure tank 10. The liner 12 is injection blow molded by a mold device 62, which will be described later. The liner 12 includes a round tubular shaped cylinder portion 18, a pair of dome portions 20 (hereinafter, referred to as first and second dome portions 20a and 20b) which are disposed at end parts in the axial direction of the cylinder portion 18, and a pair of first and second attachments 22 and 24.

The cylinder portion 18 is formed in a round tubular shape and with a constant diameter along the axial direction. The interior of the cylinder portion 18 includes a gas filling chamber 26 that is filled with hydrogen gas.

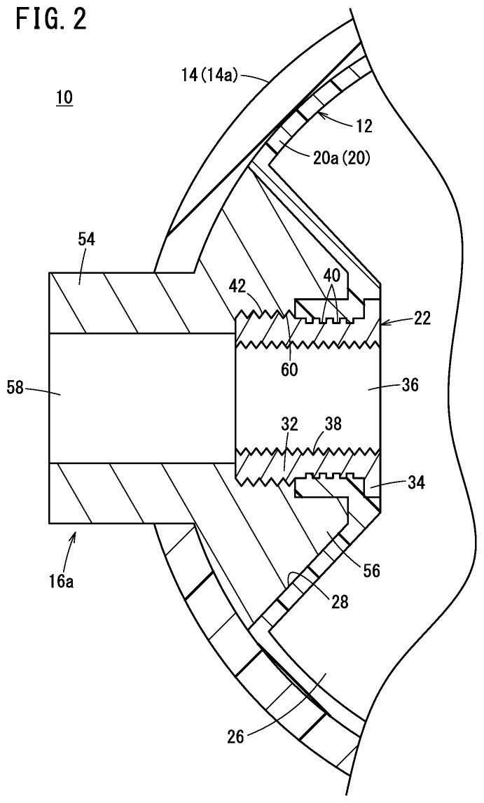

As shown in FIG. 2, the first dome portion 20a is arranged at one end in the axial direction of the cylinder portion 18. The first dome portion 20a is of a curved shape that gradually curves radially inward in a direction away from the cylinder portion 18. When viewed from a direction orthogonal to an axial direction of the liner 12, the cross-sectional shape of the first dome portion 20a is a substantially semicircular shape. The cross-sectional shape of the first dome portion 20a may be, for example, an elliptical shape. The first dome portion 20a includes a first recessed part 28 in the center thereof that is recessed in the axial direction with respect to the first dome portion 20a. The first recessed part 28 is arranged on an axial line of the first dome portion 20a.

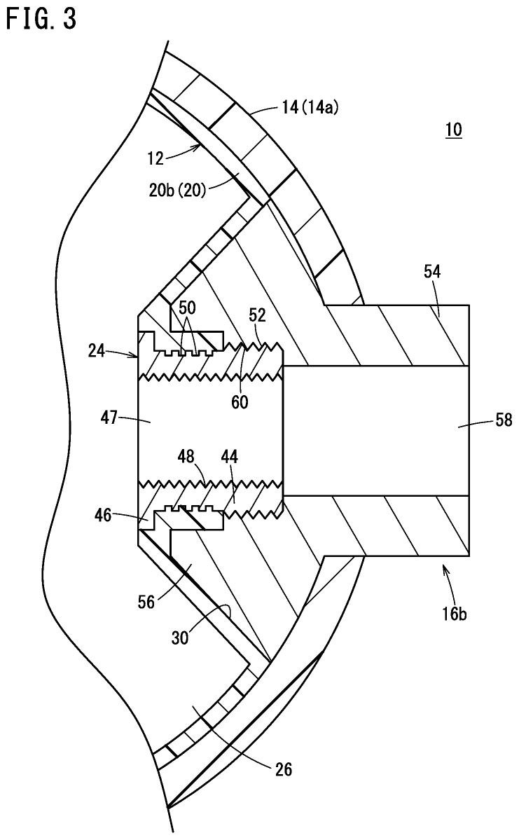

As shown in FIG. 3, the second dome portion 20b is arranged at another end in the axial direction of the cylinder portion 18. The second dome portion 20b is of a curved shape that gradually curves radially inward in a direction away from the cylinder portion 18. When viewed from a direction orthogonal to the axial direction of the liner 12, the cross-sectional shape of the second dome portion 20b is a semicircular shape. In the axial direction of the liner 12, the first dome portion 20a and the second dome portion 20b are curved radially inward in a manner so as to reduce in diameter in directions to separate away from each other. The second dome portion 20b includes a second recessed part 30 in the center thereof that is recessed in the axial direction with respect to the second dome portion 20b. The second recessed part 30 is arranged on an axial line of the second dome portion 20b.

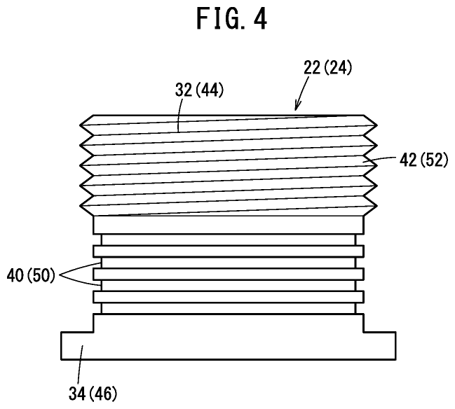

As shown in FIG. 4, the first and second attachments 22 and 24 are formed in an annular shape from a metal material. As shown in FIG. 2, the first attachment 22 is arranged at an axial center of the first dome portion 20a. The first attachment 22 is arranged on an axial line of the liner 12. An axial line of the first attachment 22 and the axial line of the liner 12 are coaxial.

The first attachment 22 is arranged on an axial line of the cylinder portion 18. The first attachment 22 is disposed concentrically with the first dome portion 20a and is integrally molded therewith. One portion of the first attachment 22 is placed in the first recessed part 28 of the first dome portion 20a. The first attachment 22 is equipped with a round tubular shaped first tubular member 32, and a first flange member 34 that extends in a radially outward direction from an end part of the first tubular member 32. The diameter of the first tubular member 32 is constant in the axial direction. The interior of the first tubular member 32 includes a first hole portion 36. The first hole portion 36 is formed at an axial center of the first tubular member 32 and penetrates along the axial direction of the first attachment 22. The first tubular member 32 is insert molded with respect to the first dome portion 20a. The first tubular member 32 is arranged on the axial line of the first dome portion 20a.

The first tubular member 32 is equipped with a first female threaded portion 38. The first female threaded portion 38 is provided on an inner circumferential surface of the first hole portion 36 of the first attachment 22. The first female threaded portion 38 is formed along the axial direction of the first hole portion 36.

An outer circumferential surface of the first tubular member 32 includes a first groove portion 40 and a first fastening member 42. The first groove portion 40 is formed in an annular shape along the circumferential direction of the outer circumferential surface of the first tubular member 32. The first groove portion 40 is recessed with respect to the outer circumferential surface of the first tubular member 32. A plurality of the first groove portions 40 are provided to be separated apart from each other in the axial direction of the first tubular member 32. At a time when the first tubular member 32 is insert molded with respect to the first dome portion 20a, one part of the first dome portion 20a is inserted into the interior of the first groove portions 40. As a result, the first tubular member 32 is fixed to the first dome portion 20a, and movement of the first attachment 22 in the axial direction with respect to the first dome portion 20a is prevented.

The first fastening member 42 is arranged closer to a distal end side of the first tubular member 32 than the first groove portion 40 is. The first fastening member 42 includes male threads formed on an outer circumferential surface thereof. The first flange member 34 is formed in an annular shape. The first flange member 34 is arranged closer to a central side in the axial direction of the cylinder portion 18 than the first tubular member 32 is. The first flange member 34 is arranged so as to face the gas filling chamber 26.

As shown in FIG. 3, the second attachment 24 is arranged on the axial line of the cylinder portion 18. The second attachment 24 is disposed concentrically with the second dome portion 20b and is integrally molded therewith. The second attachment 24 and the first attachment 22 are arranged coaxially. One portion of the second attachment 24 is placed in the second recessed part 30 of the second dome portion 20b. The second attachment 24 is equipped with a round tubular shaped second tubular member 44, and a second flange member 46 that extends in a radially outward direction from an end part of the second tubular member 44. The diameter of the second tubular member 44 is constant in the axial direction. The interior of the second tubular member 44 includes a second hole portion 47. The second hole portion 47 is formed at an axial center of the second tubular member 44 and penetrates along the axial direction of the second attachment 24. The second tubular member 44 of the second attachment 24 is insert molded with respect to the second dome portion 20b. The second tubular member 44 is arranged on the axial line of the second dome portion 20b. The second hole portion 47 and the first hole portion 36 are disposed concentrically.

The second tubular member 44 is equipped with a second female threaded portion 48. The second female threaded portion 48 is provided on an inner circumferential surface of the second hole portion 47 of the second attachment 24. The second female threaded portion 48 is formed along the axial direction of the second hole portion 47. The first female threaded portion 38 of the first attachment 22 and the second female threaded portion 48 have the same thread pitch.

An outer circumferential surface of the second tubular member 44 includes a second groove portion 50 and a second fastening member 52. The second groove portion 50 is formed in an annular shape along the circumferential direction of the outer circumferential surface of the second tubular member 44. The second groove portion 50 is recessed with respect to the outer circumferential surface of the second tubular member 44. A plurality of the second groove portions 50 are provided to be separated apart from each other in the axial direction of the second tubular member 44. At a time when the second tubular member 44 is insert molded with respect to the second dome portion 20b, one part of the second dome portion 20b is inserted into the interior of the second groove portions 50. As a result, the second tubular member 44 is fixed to the second dome portion 20b, and movement of the second attachment 24 in the axial direction with respect to the second dome portion 20b is prevented.

The second fastening member 52 is arranged closer to a distal end side of the second tubular member 44 than the second groove portion 50 is. The second fastening member 52 includes male threads formed on an outer circumferential surface thereof. The second flange member 46 is formed in an annular shape. The second flange member 46 is arranged closer to a central side in the axial direction of the cylinder portion 18 than the second tubular member 44 is. The second flange member 46 is arranged so as to face the gas filling chamber 26.

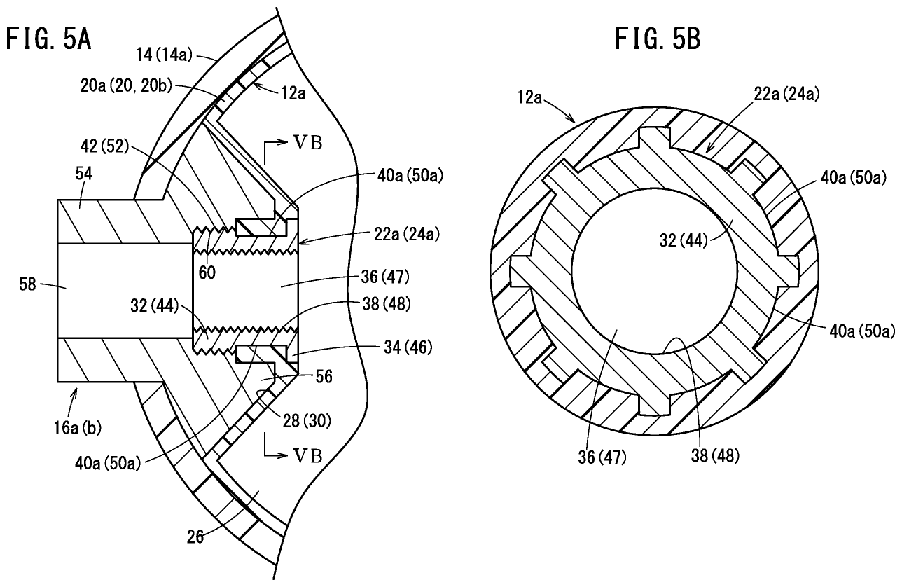

The first groove portions 40 of the first attachment 22 and the second groove portions 50 of the second attachment 24 are not limited to being formed in an annular shape along the circumferential direction of the first and second tubular members 32 and 44. A liner 12a according to a modification shown in FIG. 5A is equipped with first and second attachments 22a and 24a. The first tubular member 32 of the first attachment 22a includes a first groove portion 40a. The first groove portion 40a is formed on the outer circumferential surface of the first tubular member 32. The first groove portion 40a extends in the axial direction of the first tubular member 32. As shown in FIG. 5B, a plurality of the first groove portions 40a are provided to be separated apart from each other along the outer circumferential surface of the first tubular member 32. As shown in FIG. 5A, the second tubular member 44 of the second attachment 24a includes a second groove portion 50a. The second groove portion 50a is formed on the outer circumferential surface of the second tubular member 44. The second groove portion 50a extends in the axial direction of the second tubular member 44. As shown in FIG. 5B, a plurality of the second groove portions 50a are provided to be separated apart from each other along the outer circumferential surface of the second tubular member 44.

As shown in FIG. 5A, at a time when the first tubular member 32 is insert molded with respect to the first dome portion 20a, one part of the first dome portion 20a is inserted into the interior of the first groove portions 40a. As a result, the first tubular member 32 is fixed to the first dome portion 20a, and movement of the first attachment 22a in the direction of rotation with respect to the first dome portion 20a is prevented by the first groove portions 40a. Further, at a time when the second tubular member 44 is insert molded with respect to the second dome portion 20b, one part of the second dome portion 20b is inserted into the interior of the second groove portions 50a. As a result, the second tubular member 44 is fixed to the second dome portion 20b, and movement of the second attachment 24a in the direction of rotation with respect to the second dome portion 20b is prevented by the second groove portions 50a.

As shown in FIG. 1, the reinforcing layer 14 is disposed on the outer circumferential surface of the liner 12. The reinforcing layer 14 covers the outer circumferential surface of the cylinder portion 18, and the outer circumferential surfaces of the first and second dome portions 20a and 20b. The reinforcing layer 14 is formed of a fiber reinforced resin (FRP) in which a resin base material is impregnated into reinforcing fibers 14a. In a manufacturing process of manufacturing the high pressure tank 10, the reinforcing fibers 14a that are impregnated with the resin are wound around the outer circumferential surface of the liner 12 a plurality of times by a non-illustrated filament winding device. The reinforcing layer 14 is a laminated body obtained by winding the reinforcing fibers 14a around the liner 12, and thereafter, performing heating to cause the resin to harden.

As shown in FIG. 2 and FIG. 3, the first and second bosses 16a and 16b are caps that are formed in an annular shaped from a metal material. The first and second bosses 16a and 16b are arranged respectively on the first and second dome portions 20a and 20b. Each of the first and second bosses 16a and 16b is equipped with a boss main body 54 and a flange member 56. The boss main body 54 is of a round tubular shape in which a gas flow passage 58 is included. The gas flow passage 58 penetrates in the axial direction through the center of the boss main body 54. A non-illustrated pipe can be connected to a distal end of the boss main body 54. An inner circumferential surface of a proximal end of the boss main body 54 includes a fastened portion 60. The fastened portion 60 includes female threads formed on an inner circumferential surface thereof.

The flange member 56 is arranged at the proximal end of the boss main body 54. The flange member 56 expands in a radially outward direction from an outer circumferential surface of the boss main body 54. The flange member 56 of the first boss 16a is accommodated and fixed in the first recessed part 28 (refer to FIG. 2). The flange member 56 of the second boss 16b is accommodated and fixed in the second recessed part 30 (refer to FIG. 3).

As shown in FIG. 2, at a time when the first boss 16a is fixed to the first recessed part 28, the distal end of the first tubular member 32 of the first attachment 22 is inserted into the proximal end of the first boss 16a, and the first fastening member 42 is fastened to the fastened portion 60. Consequently, the first boss 16a and the first attachment 22 are connected in the axial direction. The first boss 16a and the first attachment 22 are fixed concentrically. The gas flow passage 58 of the first boss 16a and the gas filling chamber 26 of the liner 12 communicate with each other via the first hole portion 36.

As shown in FIG. 3, at a time when the second boss 16b is fixed to the second recessed part 30, the distal end of the second tubular member 44 of the second attachment 24 is inserted into the proximal end of the second boss 16b, and the second fastening member 52 is fastened to the fastened portion 60. Consequently, the second boss 16b and the second attachment 24 are connected in the axial direction. The second boss 16b and the second attachment 24 are fixed concentrically. The gas flow passage 58 of the second boss 16b and the gas filling chamber 26 of the liner 12 communicate with each other via the second hole portion 47.

Next, a description will be given concerning the mold device 62 for blow molding the liner 12.

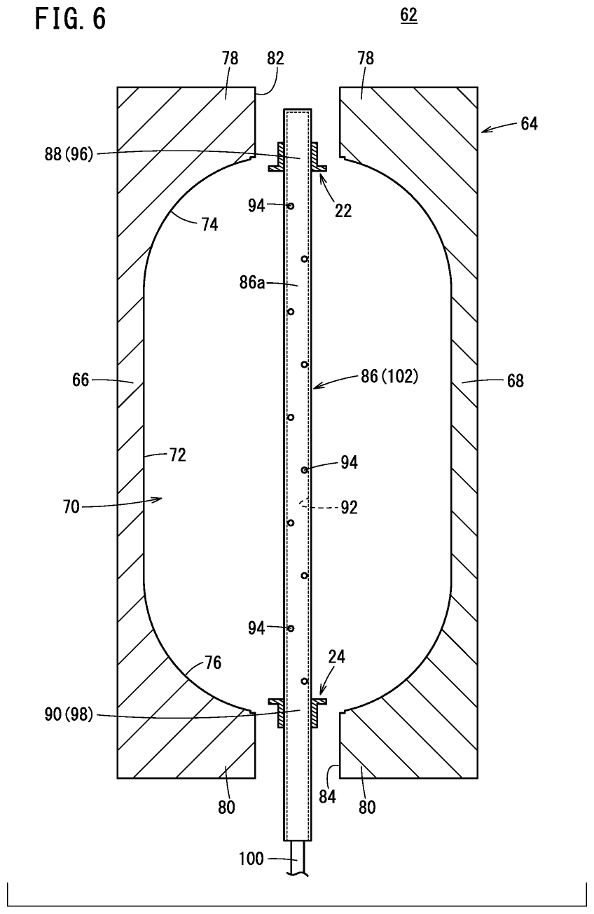

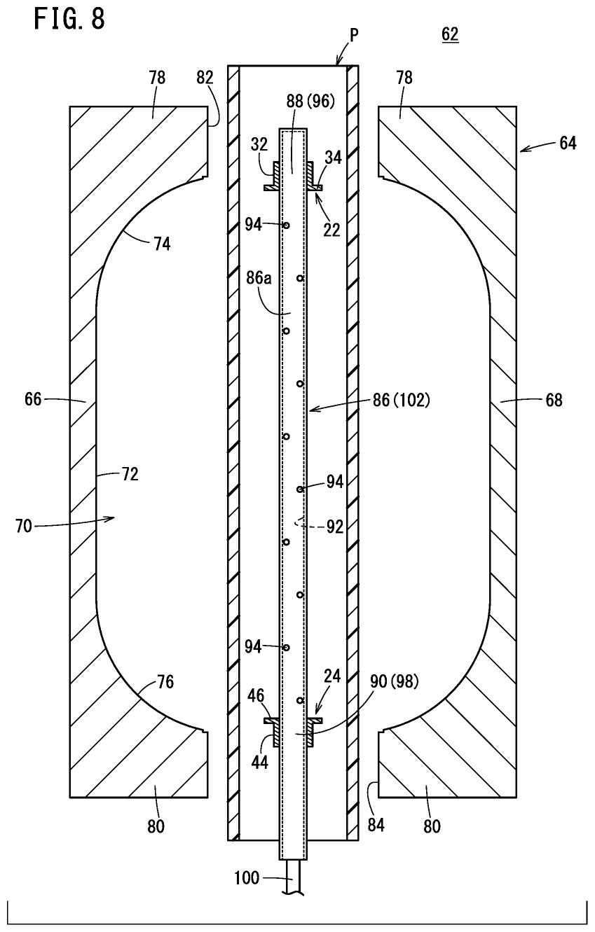

The mold device 62 shown in FIG. 6 is a blow molding device that subjects a parison P (refer to FIG. 8), which is made of a thermoplastic resin, to injection blow molding and thereby obtains the liner 12 from the deformed parison P.

The mold device 62 includes a mold 64 that is capable of molding the liner 12. The mold 64 includes first and second molds 66 and 68 that are made from a metal material and are capable of being separated apart from each other. In the interior of the mold 64, there is included a molding member 70 corresponding to the outer shape of the liner 12, which is a molded product. The molding member 70 is formed so as to straddle across the first mold 66 and the second mold 68. The first and second molds 66 and 68 are half-split bodies that divide the molding member 70 into two sections. The molding member 70 includes a cylinder molding portion 72, and first and second dome molding portions 74 and 76 arranged at end parts of the cylinder molding portion 72.

The cylinder molding portion 72 is orthogonal to the dividing direction of the first and second molds 66 and 68. When viewed from a direction orthogonal to the dividing direction of the first and second molds 66 and 68, the cross-sectional shape of the cylinder molding portion 72 is a circular shape. The first dome molding portion 74 is arranged at one end part in the axial direction of the cylinder molding portion 72. The first dome molding portion 74 is of a hemispherical shape that forms a convex shape in a direction away from the cylinder molding portion 72. The second dome molding portion 76 is arranged at another end part in the axial direction of the cylinder molding portion 72. The second dome molding portion 76 is of a hemispherical shape that forms a convex shape in a direction away from the cylinder molding portion 72.

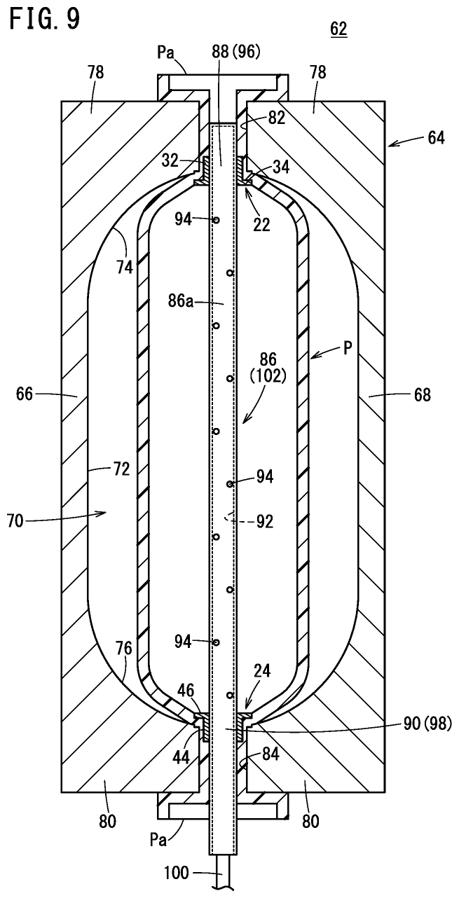

The mold 64 includes first and second connecting portions 78 and 80. The first connecting portion 78 is arranged above the first dome molding portion 74. As shown in FIG. 9, at a time when the mold 64 is closed, the first connecting portion 78 serves as a portion that grips and holds one end part of the parison P between the first mold 66 and the second mold 68. The second connecting portion 80 is arranged below the second dome molding portion 76. At a time when the mold 64 is closed, the second connecting portion 80 serves as a portion that grips and holds another end part of the parison P between the first mold 66 and the second mold 68.

The first connecting portion 78 includes a first retaining hole 82 that is capable of retaining the first attachment 22 during molding of the liner 12. The first retaining hole 82 extends in the axial direction of the mold 64 and communicates with the first dome molding portion 74. The first retaining hole 82 is formed to straddle across the first mold 66 and the second mold 68. The second connecting portion 80 includes a second retaining hole 84 that is capable of retaining the second attachment 24 during molding of the liner 12. The second retaining hole 84 extends in the axial direction of the mold 64 and is formed to straddle across the first mold 66 and the second mold 68. The second retaining hole 84 penetrates in the axial direction from the second dome molding portion 76 to an outer side of the mold 64.

Next, a description will be given concerning the method for manufacturing the liner 12 (the high pressure tank 10). Moreover, it should be noted that the structures of the liner 12 and the high pressure tank 10 including the liner 12 shown in FIGS. 8 to 13 are represented schematically.

First, in a shaft preparation step shown in FIG. 6, a shaft assembly 102 is prepared. The shaft assembly 102 includes a shaft 86 in which an air supply hole 94 is included, and the first and second attachments 22 and 24 that are attached to the outer circumferential portion of the shaft 86.

The shaft 86 is a tubular body that is formed in a straight line shape and is arranged at the center of the mold 64. The shaft 86 is arranged along the axial direction of the mold 64. The shaft 86 is arranged on the mold dividing line between the first mold 66 and the second mold 68. The diameter of the shaft 86 is constant in the axial direction.

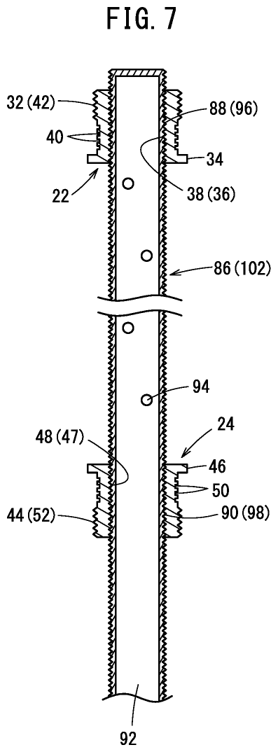

As shown in FIG. 7, the shaft 86 includes a shaft main body 86a, a first supporting member 88, a second supporting member 90, an air flow passage 92, and the air supply hole 94. The first supporting member 88 and the second supporting member 90 are arranged to be separated apart from each other in the axial direction of the shaft 86. The first supporting member 88 is disposed at one end part of the shaft main body 86a in the axial direction. The first supporting member 88 supports the first attachment 22 in a detachable manner.

The outer circumferential surface of the first supporting member 88 has a first male threaded portion 96. The first male threaded portion 96 is formed over a predetermined range in the axial direction of the first supporting member 88. The first male threaded portion 96 is capable of being screw engaged into the first female threaded portion 38 of the first attachment 22. Moreover, it should be noted that the first supporting member 88 and the first attachment 22 may be supported by being fitted mutually with each other, and the first supporting member 88 and the first attachment 22 may be engaged with each other in the axial direction by a protrusion or the like that is projected out from at least one of the first supporting member 88 or the first attachment 22.

The second supporting member 90 is disposed on another end part side of the shaft main body 86a in the axial direction, with respect to the first supporting member 88. The second supporting member 90 supports the second attachment 24 in a detachable manner. Moreover, it should be noted that the second supporting member 90 and the second attachment 24 may be supported by being fitted mutually with each other. Further, the second supporting member 90 and the second attachment 24 may be engaged with each other in the axial direction by a protrusion or the like that is projected out from at least one of the second supporting member 90 or the second attachment 24.

The outer circumferential surface of the second supporting member 90 has a second male threaded portion 98. The second male threaded portion 98 is formed over a predetermined range in the axial direction of the second supporting member 90. The second male threaded portion 98 is capable of being screw engaged into the second female threaded portion 48 of the second attachment 24. The first male threaded portion 96 and the second male threaded portion 98 are separated apart from each other in the axial direction of the shaft 86 and are arranged at different positions. The first male threaded portion 96 and the second male threaded portion 98 have the same thread pitch.

As shown in FIG. 6, the air flow passage 92 is formed in the interior of the shaft 86. The air flow passage 92 opens at another end part in the axial direction of the shaft 86. An air supply pipe 100 is connected to the other end part in the axial direction of the shaft 86, and air is supplied to the air flow passage 92 through the air supply pipe 100. The air flow passage 92 does not open at the one end part in the axial direction of the shaft 86.

The air supply hole 94 opens on an outer circumferential surface of the shaft main body 86a. A plurality of the air supply holes 94 are provided and are arranged substantially equally apart from each other in the axial direction and the circumferential direction of the shaft 86. Each of the air supply holes 94 penetrates through the shaft 86 in the radial direction and communicates with the air flow passage 92. At a time when air is supplied to the air flow passage 92, the air is led out in a radially outward direction from the outer circumferential surface of the shaft main body 86a through the plurality of the air supply holes 94.

As shown in FIG. 7, the first supporting member 88 of the shaft 86 is inserted into the first hole portion 36 of the first attachment 22. The first female threaded portion 38 of the first attachment 22 is screw engaged with the first male threaded portion 96 of the first supporting member 88. The second supporting member 90 of the shaft 86 is inserted into the second hole portion 47 of the second attachment 24. The second female threaded portion 48 of the second attachment 24 is screw engaged with the second male threaded portion 98 of the second supporting member 90. The other end part side of the shaft 86 is exposed to the exterior of the mold 64 through the second retaining hole 84 of the mold 64 (refer to FIG. 6).

In the shaft preparation step, the first supporting member 88 of the shaft 86 is inserted into the first hole portion 36 of the first attachment 22. By causing the shaft 86 and the first attachment 22 to rotate relatively, the first male threaded portion 96 and the first female threaded portion 38 are screw engaged with each other. The first attachment 22 is retained by the first supporting member 88. Further, the second supporting member 90 of the shaft 86 is inserted into the second hole portion 47 of the second attachment 24. By causing the shaft 86 and the second attachment 24 to rotate relatively, the second male threaded portion 98 and the second female threaded portion 48 are screw engaged with each other. The second attachment 24 is retained by the second supporting member 90. Consequently, in the shaft preparation step, the shaft assembly 102 is formed in which the first attachment 22 is retained by the first supporting member 88 of the shaft 86, and the second attachment 24 is retained by the second supporting member 90 of the shaft 86. In the axial direction of the shaft 86, the first attachment 22 and the second attachment 24 are arranged to be separated apart from each other. In the axial direction of the shaft 86, the first tubular member 32 of the first attachment 22 and the second tubular member 44 of the second attachment 24 are arranged on the sides separated apart from each other. The air supply pipe 100 is connected to the other end part of the shaft 86.

Next, in the parison supply step shown in FIG. 8, the first and second molds 66 and 68 of the mold device 62 are placed in an open state in which they are separated apart from each other, and the parison P of a tubular shape made of a resin material is pushed out from a non-illustrated extrusion machine and is supplied to the molding member 70 of the mold 64. Moreover, it should be noted that the parison P which is formed in advance by the extrusion machine may be supplied to the mold 64. The parison P is arranged between the first mold 66 and the second mold 68, and is arranged so as to be orthogonal to the dividing direction of the first mold 66 and the second mold 68. The parison P is supplied along the axial direction around the outer circumference of the shaft assembly 102. Consequently, the shaft assembly 102 is accommodated in the interior of the parison P. The parison P and the shaft assembly 102 are arranged coaxially. The outer circumferential surface of the shaft 86 and the parison P are arranged to be separated apart from each other in the radial direction. Moreover, it should be noted that the shaft assembly 102 may be inserted into the interior of the parison P that has been arranged in advance. The first attachment 22 faces toward the first connecting portion 78 (the first retaining hole 82) of the first and second molds 66 and 68. The second attachment 24 faces toward the second connecting portion 80 (the second retaining hole 84) of the first and second molds 66 and 68.

Next, a blow molding step is carried out in which the liner 12 is blow molded from the parison P.

First, as shown in FIG. 9, the first mold 66 and the second mold 68 are caused to move toward each other, and the mold 64 is closed. The mold closing direction is a direction orthogonal to the axial direction of the shaft 86. Accompanying the closing of the mold 64, the parison P, the first attachment 22, and the first supporting member 88 are retained by the first connecting portion 78. At this time, one portion of the parison P, and the first attachment 22 and the first supporting member 88 are retained by the first retaining hole 82 of the mold 64. The one portion of the parison P is pressed and crushed in a radially inward direction by the first connecting portion 78, and is thereby reduced in diameter. Accompanying the closing of the mold 64, the parison P, the second attachment 24, and the second supporting member 90 are retained by the second connecting portion 80. At this time, one portion of the parison P, and the second attachment 24 and the second supporting member 90 are retained by the second retaining hole 84 of the mold 64. The one portion of the parison P is pressed and crushed in a radially inward direction by the second connecting portion 80, and is thereby reduced in diameter. The other end part of the shaft 86 is arranged on the exterior of the mold 64 via the second retaining hole 84. In the interior of the mold 64, an outer circumferential surface of the parison P faces toward the molding member 70. Moreover, it should be noted that one end part in the axial direction of the parison P projects out to the outer side of one end part of the first and second molds 66 and 68. Another end part in the axial direction of the parison P projects out to the outer side of another end part of the first and second molds 66 and 68.

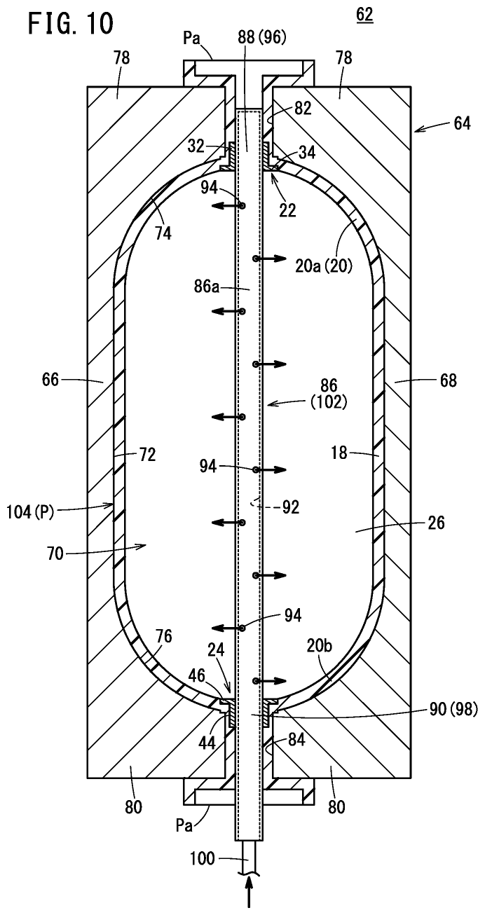

As shown in FIG. 10, air is supplied from an air supply source (not illustrated) to the air flow passage 92 of the shaft 86 through the air supply pipe 100. The air in the air flow passage 92 is led out to the outer side of the shaft 86 through the plurality of air supply holes 94. In the axial direction and the circumferential direction of the shaft 86, the amount of the air that is led out from each of the air supply holes 94 is approximately equal. When the air is led out into the interior of the parison P from the shaft 86, the parison P is pushed outwardly toward the molding member 70 by the pressure of the air, and thereby expands (becomes deformed). By the parison P being expanded by the air, the outer surface of the parison P is pressed against the molding member 70. By the parison P being deformed along the cylinder molding portion 72 and the first and second dome molding portions 74 and 76, the parison P, which is in close contact with the molding member 70, is formed into a tubular shape. At this time, the thickness of the parison P that has been deformed along the molding member 70 becomes approximately constant.

The cylinder portion 18 of the liner 12 is molded from the parison P in the cylinder molding portion 72, and the first and second dome portions 20a and 20b are molded from the parison P respectively in the first and second dome molding portions 74 and 76. In the top part of the first dome molding portion 74, the first tubular member 32 of the first attachment 22 and the parison P are integrally molded (insert molded). The first attachment 22 is molded concentrically with the first dome portion 20a. At this time, one portion of the parison P enters the first groove portion 40 of the first tubular member 32. The second tubular member 44 of the second attachment 24 and the parison P are integrally molded (insert molded). The second attachment 24 is molded concentrically with the second dome portion 20b. At this time, one portion of the parison P enters the second groove portion 50 of the second tubular member 44.

After the parison P is cooled and solidified, the supply of the air to the shaft 86 is stopped. Consequently, a liner molded body 104 is obtained which includes the cylinder portion 18, and the first and second dome portions 20a and 20b that are formed at both end parts of the cylinder portion 18, and in which the first and second attachments 22 and 24 are integrally molded with the first and second dome portions 20a and 20b. The air supply pipe 100 is removed from the other end part of the shaft 86.

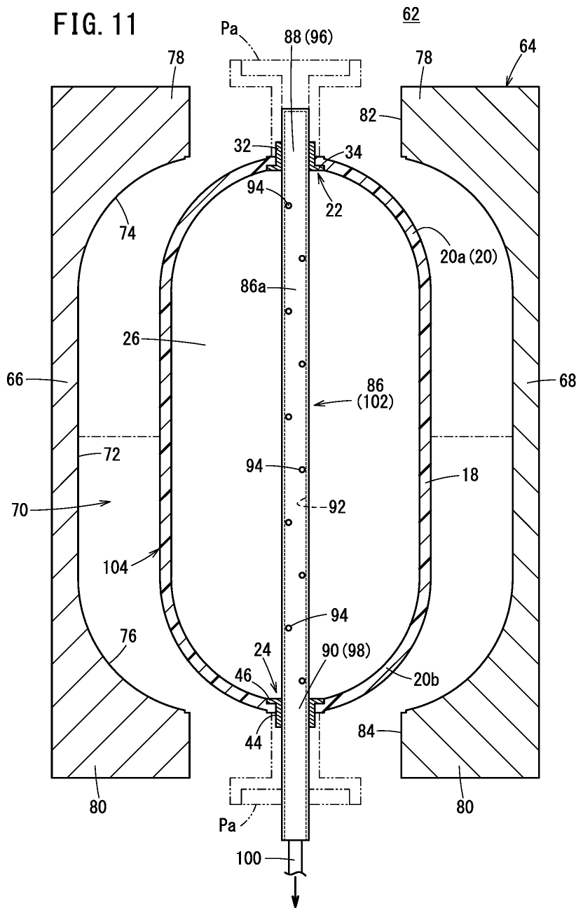

Next, as shown in FIG. 11, the first and second molds 66 and 68 are separated from each other, and the liner molded body 104 is taken out. The first mold 66 and the second mold 68 are moved in directions to separate away from each other, and the liner molded body 104 is taken out from the molding member 70 of the opened mold 64. The mold opening direction of the mold 64 is a direction orthogonal to the axial direction of the shaft 86. Surplus portions Pa of the parison P are formed at one end part and another end part in the axial direction of the liner molded body 104. The surplus portions Pa are unnecessary portions of the parison P that become excessive portions on the exterior of the mold 64. The surplus portions Pa are removed by a non-illustrated cutting device.

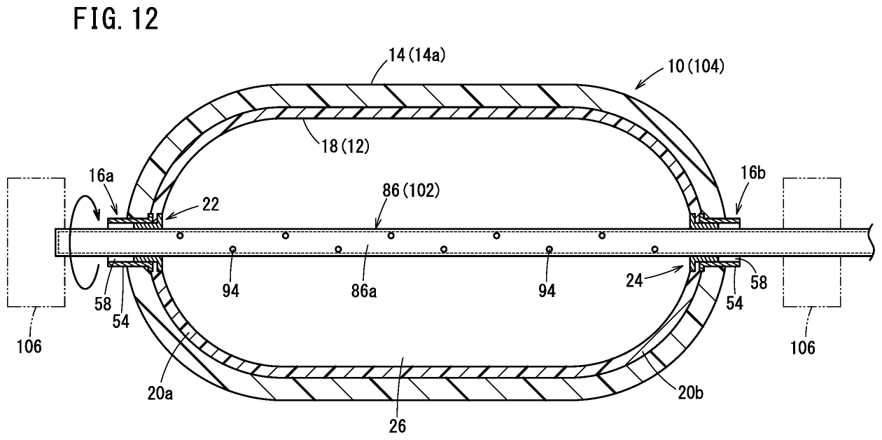

Next, as shown in FIG. 12, a boss attachment step of attaching the first and second bosses 16a and 16b to the first and second attachments 22 and 24, and a filament winding step of forming the reinforcing layer 14 on an outer circumferential surface of the liner molded body 104 are carried out. In the boss attachment step, the first boss 16a is brought closer to the first tubular member 32 of the first attachment 22 from the flange member 56 side. The flange member 56 is inserted into the first recessed part 28, and the fastened portion 60 of the boss main body 54 and the first fastening member 42 of the first tubular member 32 are screw engaged with each other (refer to FIG. 2). Consequently, the first attachment 22 and the first boss 16a are coaxially connected. The gas flow passage 58 of the first boss 16a and the first hole portion 36 communicate with each other.

In the boss attachment step, the second boss 16b is brought closer to the second tubular member 44 of the second attachment 24 from the flange member 56 side. The flange member 56 is inserted into the second recessed part 30, and the fastened portion 60 of the boss main body 54 and the second fastening member 52 of the second tubular member 44 are screw engaged with each other (refer to FIG. 3). Consequently, the second attachment 24 and the second boss 16b are coaxially connected, and the first boss 16a and the second boss 16b are disposed concentrically. The gas flow passage 58 of the second boss 16b and the second hole portion 47 communicate with each other.

After the boss attachment step, the filament winding step is carried out. The one end part and the other end part in the axial direction of the shaft 86 are supported by a rotation drive unit 106 of a non-illustrated filament winding device. By driving the rotation drive unit 106, the liner molded body 104 rotates about the shaft 86. The reinforcing layer 14 is formed by winding the reinforcing fibers 14a a plurality of times around the outer circumferential surface of the liner molded body 104, and thereafter, performing heating to cause the resin to harden. More specifically, in the filament winding step, the shaft 86 can be used as a jig for fixing and causing the liner molded body 104 to rotate. By forming the reinforcing layer 14 on the outer circumferential surface of the liner molded body 104, the high pressure tank 10 including the liner molded body 104 is constructed.

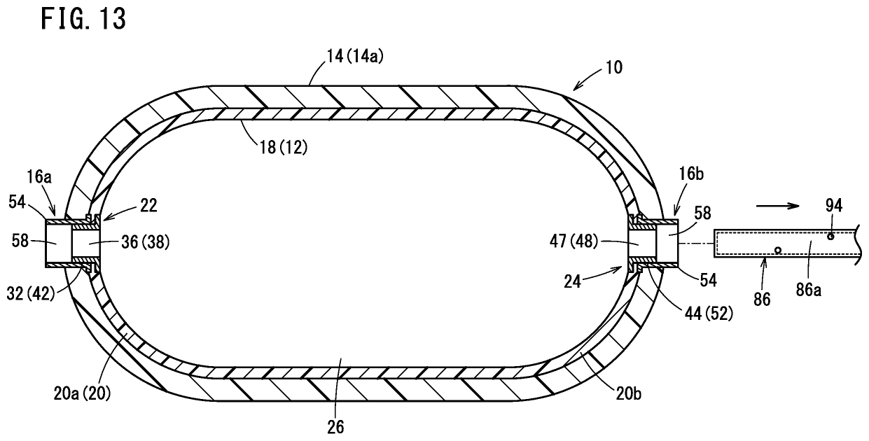

Next, as shown in FIG. 13, a detachment step of removing the shaft 86 from the liner molded body 104 is carried out. Moreover, it should be noted that the detachment step may be carried out prior to the filament winding step. In this case, instead of the shaft 86, another jig is used to thereby cause the liner 12 from which the shaft 86 has been removed to rotate.

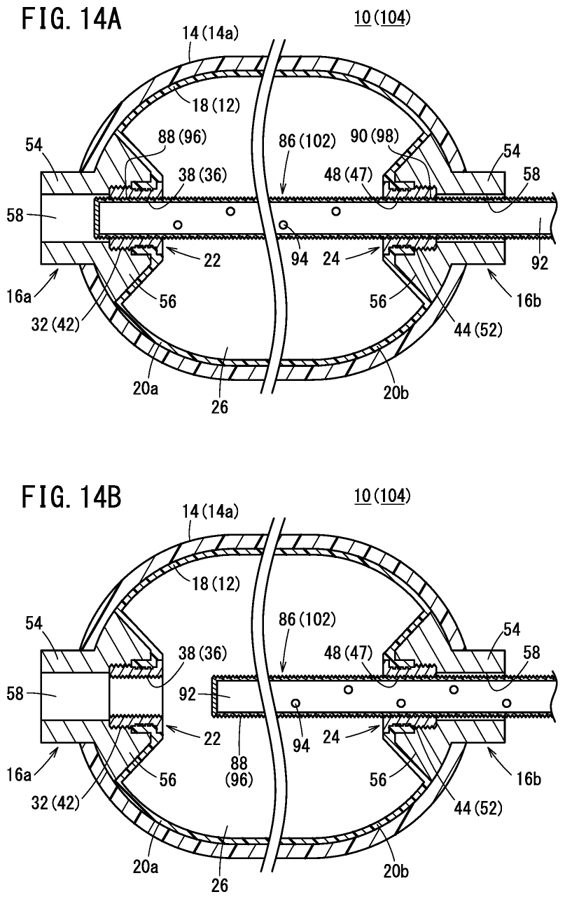

In the detachment step of removing the shaft 86, in a state in which the liner molded body 104 shown in FIG. 14A is retained, the shaft 86 is made to rotate with respect to the liner molded body 104. The direction of rotation of the shaft 86 becomes opposite to the direction of rotation when the shaft 86 is assembled onto the first and second attachments 22 and 24 (in the case of forming the shaft assembly 102). Accompanying the rotation of the shaft 86, the screw engagement between the first male threaded portion 96 of the first supporting member 88 and the first female threaded portion 38 of the first attachment 22 is released (refer to FIG. 14B), and the screw engagement between the second male threaded portion 98 of the second supporting member 90 and the second female threaded portion 48 of the second attachment 24 is released. More specifically, the state in which the shaft 86 is retained with respect to the first and second attachments 22 and 24 is released, and the shaft 86 becomes capable of being removed from the first and second attachments 22 and 24. As shown in FIG. 13, by causing the shaft 86 to move in the axial direction from the first attachment 22 toward the second attachment 24, the first hole portion 36 and the second hole portion 47 are disposed concentrically. The shaft 86 is taken out to the exterior of the liner molded body 104 through the first and second hole portions 36 and 47. Consequently, the liner 12 (the high pressure tank 10) formed by removing the shaft 86 from the liner molded body 104 is obtained.

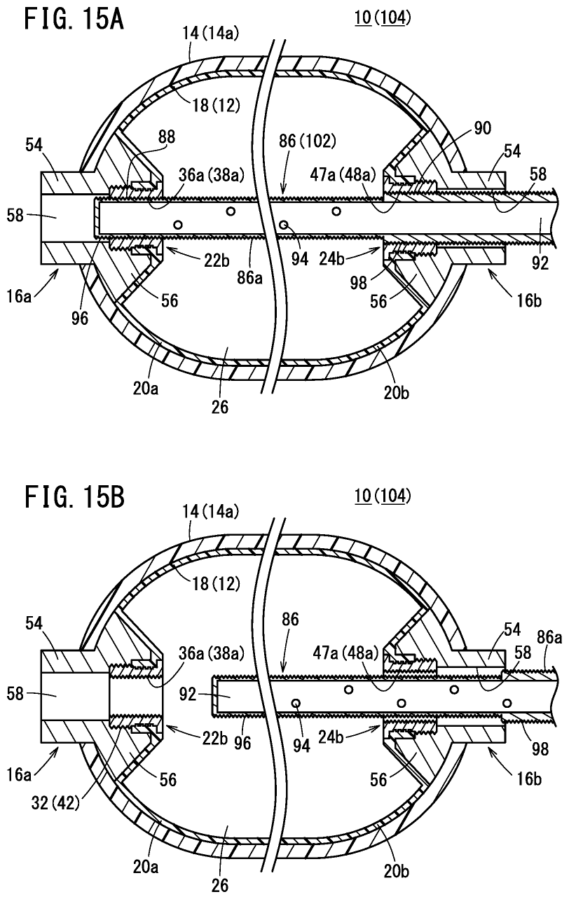

Moreover, as shown in the first modification of FIG. 15A, the inner diameter of a second hole portion 47a of a second attachment 24b may be made larger than the inner diameter of a first hole portion 36a of a first attachment 22b, and the diameter of the second supporting member 90 of the shaft 86 may be made larger than the diameter of the first supporting member 88 of the shaft 86. In accordance therewith, as shown in FIG. 15B, in the detachment step, the shaft 86 is removed from the first and second attachments 22b and 24b. In the detachment step, by causing the shaft 86 to rotate relatively with respect to the liner molded body 104, the screw engagement between the first male threaded portion 96 and a first female threaded portion 38a is released, and the screw engagement between the second male threaded portion 98 and a second female threaded portion 48a is released. The shaft 86 is caused to move relatively with respect to the liner molded body 104 in a direction from the first attachment 22b toward the second attachment 24b.

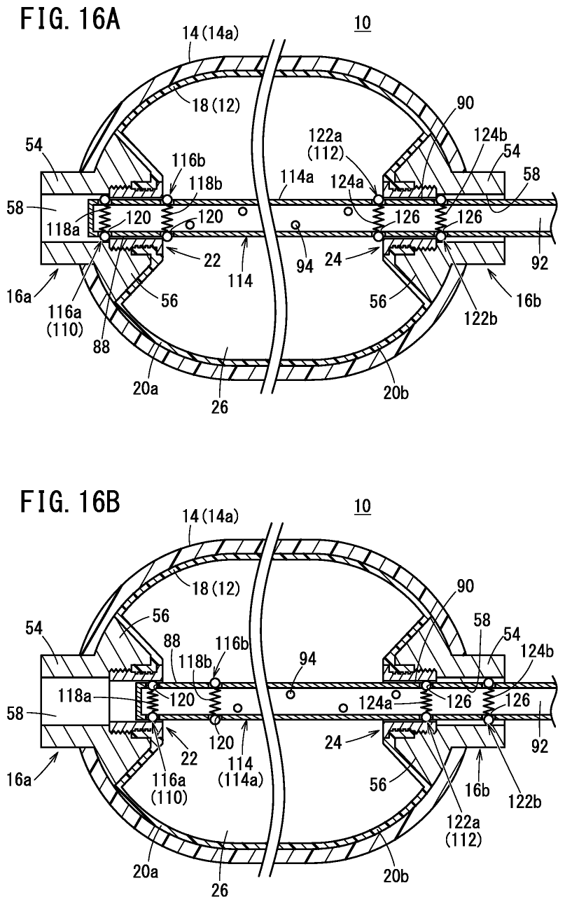

The configuration in which the shaft 86 is retained in a detachable manner with respect to the first attachments 22 and 22b and the second attachments 24 and 24b is not limited to a case of being constituted by the first female threaded portions 38 and 38a of the first attachments 22 and 22b and the first male threaded portion 96 of the shaft 86, and the second female threaded portions 48 and 48a of the second attachments 24 and 24b and the second male threaded portion 98 of the shaft 86. First and second retaining mechanisms 110 and 112 according to the second modification shown in FIG. 16A are provided on a shaft 114. The first retaining mechanism 110 is provided on a shaft main body 114a of the shaft 114, and retains the first attachment 22 in a detachable manner on the shaft main body 114a. The second retaining mechanism 112 is provided on the shaft main body 114a of the shaft 114, and retains the second attachment 24 in a detachable manner on the shaft main body 114a.

The first retaining mechanism 110 is disposed on the first supporting member 88 of the shaft main body 114a. The first retaining mechanism 110 includes a pair of first locking members 116a and 116b, and a pair of first elastic members 118a and 118b. First accommodation holes 120 of the shaft main body 114a open in a radial direction orthogonal to the axial line of the shaft 114. At a time when the first supporting member 88 of the shaft 114 is retained with respect to the first attachment 22, the pair of first locking members 116a and 116b and the first accommodation holes 120 are disposed on both sides in the axial direction of the first attachment 22. The pair of first locking members 116a and 116b and the first accommodation holes 120 are disposed in a pair and separated apart from each other in the axial direction. More specifically, in the axial direction of the shaft 114, the pair of first locking members 116a and 116b are disposed on both sides in the axial direction of the first attachment 22.

The pair of first locking members 116a and 116b are accommodated in the first accommodation holes 120, and are capable of being displaced in a radial direction of the shaft main body 114a. The first locking members 116a and 116b are disposed on the radially outer sides in the first accommodation holes 120. By the first locking members 116a and 116b projecting in a radially outward direction from the outer circumferential surface of the shaft main body 114a, the first attachment 22 is capable of being locked in the axial direction of the shaft main body 114a (the shaft 114). The first locking members 116a and 116b are locked with respect to the shaft main body 114a in a manner so as to be incapable of coming off in a radially outward direction.

The first elastic members 118a and 118b are arranged on the radially inner sides of the first locking members 116a and 116b. The first elastic members 118a and 118b have an elastic force that biases the first locking members 116a and 116b in a radially outward direction of the shaft main body 114a. Due to the elastic force of the first elastic members 118a and 118b, the pair of first locking members 116a and 116b project in a radially outward direction from the outer circumferential surface of the first supporting member 88. In accordance therewith, by the first locking members 116a and 116b, the first attachment 22 is locked in the axial direction with respect to the shaft 114. Relative movement of the first supporting member 88 of the shaft 114 and the first attachment 22 in the axial direction is prevented.

As shown in FIG. 16B, when the shaft 114 including the first retaining mechanism 110 moves relatively in the axial direction with respect to the first attachment 22, the first attachment 22 and the first locking member 116a come into contact with each other, and the first locking member 116a moves in a radially inward direction against the elastic force of the first elastic member 118a. At this time, the first locking member 116a is capable of moving to a position where it does not project out in a radially outward direction from the outer circumferential surface of the first supporting member 88 (the shaft main body 114a). When the first locking member 116a is accommodated in the first accommodation hole 120, the locking of the first attachment 22 with respect to the shaft 114 in the axial direction of the shaft 114 is released. The shaft 114 becomes capable of moving relatively in the axial direction with respect to the first attachment 22.

As shown in FIG. 16A, the second retaining mechanism 112 is disposed on the second supporting member 90 that is separated apart from the first retaining mechanism 110 in the axial direction of the shaft 114. The second retaining mechanism 112 includes a pair of second locking members 122a and 122b, and a pair of second elastic members 124a and 124b. Second accommodation holes 126 of the shaft main body 114a open in a radial direction orthogonal to the axial line of the shaft 114. At a time when the second supporting member 90 of the shaft 114 is retained with respect to the second attachment 24, the pair of second locking members 122a and 122b and the second accommodation holes 126 are disposed on both sides in the axial direction of the second attachment 24. The pair of second locking members 122a and 122b and the second accommodation holes 126 are disposed in a pair and separated apart from each other in the axial direction. More specifically, in the axial direction of the shaft 114, the pair of second locking members 122a and 122b are disposed on both sides in the axial direction of the second attachment 24.

The pair of second locking members 122a and 122b are accommodated in the second accommodation holes 126, and are capable of being displaced in the radial direction of the shaft main body 114a. The second locking members 122a and 122b are disposed on the radially outer sides in the second accommodation holes 126. By the second locking members 122a and 122b projecting in a radially outward direction from the outer circumferential surface of the shaft main body 114a, the second attachment 24 is capable of being locked in the axial direction of the shaft main body 114a (the shaft 114). The second locking members 122a and 122b are locked with respect to the shaft main body 114a in a manner so as to be incapable of coming off in a radially outward direction.

The second elastic members 124a and 124b are arranged on the radially inner sides of the second locking members 122a and 122b. The second elastic members 124a and 124b have an elastic force that biases the second locking members 122a and 122b in the radially outward direction of the shaft main body 114a. Due to the elastic force of the second elastic members 124a and 124b, the pair of second locking members 122a and 122b project in a radially outward direction from the outer circumferential surface of the second supporting member 90. In accordance therewith, by the second locking members 122a and 122b, the second attachment 24 is locked in the axial direction with respect to the shaft 114. Relative movement of the second supporting member 90 of the shaft 114 and the second attachment 24 in the axial direction is prevented.

As shown in FIG. 16B, when the shaft 114 including the second retaining mechanism 112 moves relatively in the axial direction with respect to the second attachment 24, the second attachment 24 and the second locking member 122a come into contact with each other, and the second locking member 122a moves in a radially inward direction against the elastic force of the second elastic member 124a. At this time, the second locking member 122a is capable of moving to a position where it does not project out in a radially outward direction from the outer circumferential surface of the second supporting member 90 (the shaft main body 114a). When the second locking member 122a is accommodated in the second accommodation hole 126, the locking of the second attachment 24 with respect to the shaft 114 in the axial direction of the shaft 114 is released. The shaft 114 becomes capable of moving relatively in the axial direction with respect to the second attachment 24.

The embodiment of the present invention exhibits the following advantageous effects.

According to the embodiment of the present invention, as shown in FIG. 10, in the blow molding step of molding the liner 12, the first and second attachments 22 and 24 are integrally formed with the first and second dome portions 20a and 20b of the liner 12. Therefore, as shown in FIG. 12, at a time when the first boss 16a is attached to the first attachment 22 and the second boss 16b is attached to the second attachment 24, the degree of coaxiality between the first boss 16a and the second boss 16b can be ensured. As shown in FIG. 13, after the liner molded body 104 has been molded, the shaft 86 can be removed in the axial direction from the first and second attachments 22 and 24 of the shaft assembly 102, and therefore, compared to a configuration in which the shaft remains incorporated in the liner molded body, an unnecessary increase in the weight of the high pressure tank 10 accompanying usage of the shaft 86 can be avoided.

As shown in FIG. 12, in the filament winding step, the shaft 86 of the liner molded body 104 can be used as a jig for fixing and causing the liner 12 to rotate. Therefore, in the filament winding step, there is no need to separately prepare and attach a rotating jig, and the filament winding step can be performed efficiently.

As shown in FIG. 7, in the shaft assembly 102, the first male threaded portion 96 of the shaft 86 and the first female threaded portion 38 of the first attachment 22 are screw engaged with each other, and the second male threaded portion 98 of the shaft 86 and the second female threaded portion 48 of the second attachment 24 are screw engaged with each other. Therefore, as shown in FIG. 14B, in the detachment step of removing the shaft 86 from the liner molded body 104, by causing the shaft 86 to rotate relatively with respect to the liner molded body 104, the screw engagement between the first male threaded portion 96 and the first female threaded portion 38 can be released, and the screw engagement between the second male threaded portion 98 and the second female threaded portion 48 can be released. Consequently, in the detachment step of removing the shaft 86, the shaft 86 can be easily removed from the liner molded body 104.

In the configuration shown in FIG. 15A, the inner diameter of the second hole portion 47a of the second attachment 24b is larger than the inner diameter of the first hole portion 36a of the first attachment 22b. Therefore, as shown in FIG. 15B, in the detachment step of removing the shaft 86 from the liner molded body 104, after the first male threaded portion 96 of the shaft 86 has been detached from the first female threaded portion 38a of the first attachment 22, the first male threaded portion 96 of the shaft 86 can pass through the second female threaded portion 48a of the second attachment 24 without causing the shaft 86 to rotate relatively with respect to the liner molded body 104. Therefore, the shaft 86 can be easily taken out from the liner molded body 104.

In the configuration shown in FIG. 16A, the shaft 114 includes the first locking members 116a and 116b, and the second locking members 122a and 122b. Therefore, in the shaft preparation step of assembling the shaft 114 onto the first and second attachments 22 and 24, the relative movement of the shaft 114 in the axial direction with respect to the first and second attachments 22 and 24 is prevented by the first locking members 116a and 116b and the second locking members 122a and 122b, which are biased in a radially outward direction and project out from the outer circumferential surface of the shaft main body 114a. Therefore, the first and second attachments 22 and 24 can be stably fixed to the shaft 114. In the detachment step of removing the shaft 114, the first locking members 116a and 116b and the second locking members 122a and 122b move in the radially inward direction from the outer circumferential surface of the shaft main body 114a against the elastic force of the first elastic members 118a and 118b and the second elastic members 124a and 124b, and are accommodated in the first and second accommodation holes 120 and 126. Consequently, the state in which the movement of the shaft 114 in the axial direction is prevented by the first locking members 116a and 116b and the second locking members 122a and 122b is released, it becomes possible for the shaft 114 to move relatively in the axial direction with respect to the first and second attachments 22 and 24, and the shaft 114 can be removed from the first and second attachments 22 and 24.

The above-described embodiment can be summarized in the following manner.

The above-described embodiment is characterized by the manufacturing method for manufacturing the liner (12) including the round tubular shaped cylinder portion (18), the first dome portion (20a) disposed at one end part in the axial direction of the cylinder portion, and the second dome portion (20b) disposed at the other end part in the axial direction of the cylinder portion, the manufacturing method including: the shaft preparation step, which is the shaft preparation step of preparing the shaft assembly (102) in which the annular shaped first attachment (22) and the annular shaped second attachment (24) are attached to the outer circumferential portion of the tubular shaped shaft (86, 114) including the air supply hole (94) and extending in a straight line shape, wherein the annular shaped first boss (16a) is capable of being attached to the first attachment, the annular shaped second boss (16b) is capable of being attached to the second attachment, the first attachment and the second attachment are arranged to be separated apart from each other in the axial direction of the shaft, and the shaft is capable of being removed from the first attachment and the second attachment; the parison supply step of supplying the tubular shaped parison (P) made of the resin material toward the mold device (62) for molding the liner, and arranging the shaft assembly on the inner side of the parison; the blow molding step of closing the mold device, supplying air into the parison from the air supply hole of the shaft to thereby cause the parison to expand, and obtaining the liner molded body (104) in which the first attachment including the first hole portion is integrally molded on the first dome, and the second attachment including the second hole portion disposed concentrically with the first hole portion is integrally molded on the second dome; and a detachment step of removing the shaft from the first attachment and the second attachment after the blow molding step, and taking out the shaft to the exterior of the liner molded body.

Between the blow molding step and the detachment step, there is included the filament winding step of winding the reinforcing fibers (14a) around the outer circumferential surface of the liner, wherein, in the filament winding step, the liner molded body is supported by the shaft, and the liner molded body is rotated via the shaft.

The outer circumferential surface of the shaft includes the first male threaded portion (96) and the second male threaded portion (98) provided at different positions in the axial direction of the shaft; the inner circumferential surface of the first attachment includes the first female threaded portion (38, 38a) that is capable of being screw engaged with the first male threaded portion; the inner circumferential surface of the second attachment includes the second female threaded portion (48, 48a) that is capable of being screw engaged with the second male threaded portion; in the shaft assembly, the first male threaded portion and the first female threaded portion are screw engaged with each other, and the second male threaded portion and the second female threaded portion are screw engaged with each other; and in the detachment step, by causing the shaft to rotate relatively with respect to the liner molded body, the screw engagement between the first male threaded portion and the first female threaded portion is released, and the screw engagement between the second male threaded portion and the second female threaded portion is released.

The inner diameter of the second attachment is larger than the inner diameter of the first attachment; and in the detachment step, the shaft is made to move relatively with respect to the liner molded body in a direction from the first attachment toward the second attachment.

The shaft includes: the shaft main body (114a) that extends in the axial direction of the shaft; the first retaining mechanism (110) that is provided on the shaft main body, and that retains the first attachment in a detachable manner; and the second retaining mechanism (112) that is provided on the shaft main body at a position separated apart from the first retaining mechanism in the axial direction of the shaft, and that retains the second attachment in a detachable manner; the first retaining mechanism includes the first locking member (116a, 116b) that is capable of being displaced in a radial direction of the shaft main body and projects out from the outer circumferential surface of the shaft main body to lock the first attachment, and the first elastic member (118a, 118b) that biases the first locking member outwardly in the radial direction of the shaft main body; the second retaining mechanism includes the second locking member (122a, 122b) that is capable of being displaced in the radial direction of the shaft main body and projects out from the outer circumferential surface of the shaft main body to lock the second attachment, and the second elastic member (124a, 124b) that biases the second locking member outwardly in the radial direction of the shaft main body; in the shaft preparation step, the first locking member and the second locking member project out from the outer circumferential surface of the shaft main body, and the first and second attachments engage with the shaft in the axial direction of the shaft; and in the detachment step, accompanying the relative movement of the shaft in the axial direction thereof with respect to the liner molded body, the first attachment causes the first locking member to be displaced inwardly in the radial direction of the shaft main body against the biasing force of the first elastic member, and the second attachment causes the second locking member to be displaced inwardly in the radial direction of the shaft main body against the biasing force of the second elastic member, to thereby release the engagement of the first and second attachments with the shaft in the axial direction of the shaft.

The above-described embodiment is further characterized by the high pressure tank, including: the liner made of a resin material and including the round tubular shaped cylinder portion, the curved shaped first dome portion disposed at one end part in the axial direction of the cylinder portion, and the curved shaped second dome portion disposed at the other end part in the axial direction of the cylinder portion; the annular shaped first attachment integrally molded with the first dome portion on an axial line of the cylinder portion, and including the first hole portion (36) penetrating in the axial direction of the cylinder portion; the annular shaped second attachment integrally molded with the second dome portion on the axial line of the cylinder portion, and including the second hole portion (47) that penetrates in the axial direction of the cylinder portion and is disposed concentrically with the first hole portion; the annular shaped first boss concentrically fixed to the first attachment; and the annular shaped second boss concentrically fixed to the second attachment.

The present invention is not limited to the above disclosure, and various modifications are possible without departing from the essence and gist of the present invention.

1. A manufacturing method for manufacturing a liner including a cylinder portion having a round tubular shape, a first dome portion disposed at one end part in an axial direction of the cylinder portion, and a second dome portion disposed at another end part in the axial direction of the cylinder portion, the manufacturing method comprising:
preparing a shaft assembly in which a first attachment having an annular shape and a second attachment having an annular shape are attached to an outer circumferential portion of a shaft that has a tubular shape, includes an air supply hole, and extends in a straight line shape, wherein a first boss having an annular shape is attachable to the first attachment, a second boss having an annular shape is attachable to the second attachment, the first attachment and the second attachment are arranged to be separated apart from each other in an axial direction of the shaft, and the shaft is removable from the first attachment and the second attachment;
supplying a parison having a tubular shape and made of a resin material toward a mold device configured to mold the liner, and arranging the shaft assembly on an inner side of the parison;
closing the mold device, supplying air into the parison from the air supply hole of the shaft to thereby cause the parison to expand, and obtaining a liner molded body in which the first attachment including a first hole portion is integrally molded on the first dome, and the second attachment including a second hole portion disposed concentrically with the first hole portion is integrally molded on the second dome; and
removing the shaft from the first attachment and the second attachment after the obtaining of the liner molded body, and taking out the shaft to an exterior of the liner molded body.

2. The manufacturing method according to claim 1, further comprising, between the obtaining of the liner molded body and the taking out of the shaft to the exterior of the liner molded body, winding reinforcing fibers around an outer circumferential surface of the liner,
wherein, in the winding of the reinforcing fibers, the liner molded body is supported by the shaft, and the liner molded body is rotated via the shaft.

3. The manufacturing method according to claim 1, wherein
an outer circumferential surface of the shaft includes a first male threaded portion and a second male threaded portion provided at different positions in the axial direction of the shaft,
an inner circumferential surface of the first attachment includes a first female threaded portion configured to be screw engaged with the first male threaded portion,
an inner circumferential surface of the second attachment includes a second female threaded portion configured to be screw engaged with the second male threaded portion,
in the shaft assembly, the first male threaded portion and the first female threaded portion are screw engaged with each other, and the second male threaded portion and the second female threaded portion are screw engaged with each other, and
in the taking out of the shaft to the exterior of the liner molded body, by causing the shaft to rotate relatively with respect to the liner molded body, screw engagement between the first male threaded portion and the first female threaded portion is released, and screw engagement between the second male threaded portion and the second female threaded portion is released.

4. The manufacturing method according to claim 3, wherein
an inner diameter of the second attachment is larger than an inner diameter of the first attachment, and
in the taking out of the shaft to the exterior of the liner molded body, the shaft is made to move relatively with respect to the liner molded body in a direction from the first attachment toward the second attachment.

5. The manufacturing method according to claim 1, wherein
the shaft includes:
a shaft main body extending in the axial direction of the shaft;
a first retaining mechanism provided on the shaft main body, and configured to retain the first attachment in a detachable manner; and
a second retaining mechanism provided on the shaft main body at a position separated apart from the first retaining mechanism in the axial direction of the shaft, and configured to retain the second attachment in a detachable manner,
the first retaining mechanism includes a first locking member configured to be displaced in a radial direction of the shaft main body and project out from an outer circumferential surface of the shaft main body to lock the first attachment, and a first elastic member configured to bias the first locking member outwardly in the radial direction of the shaft main body,
the second retaining mechanism includes a second locking member configured to be displaced in the radial direction of the shaft main body and project out from the outer circumferential surface of the shaft main body to lock the second attachment, and a second elastic member configured to bias the second locking member outwardly in the radial direction of the shaft main body,
in the preparing of the shaft assembly, the first locking member and the second locking member project out from the outer circumferential surface of the shaft main body, and the first and second attachments engage with the shaft in the axial direction of the shaft, and
in the taking out of the shaft to the exterior of the liner molded body, accompanying relative movement of the shaft in the axial direction thereof with respect to the liner molded body, the first attachment causes the first locking member to be displaced inwardly in the radial direction of the shaft main body against a biasing force of the first elastic member, and the second attachment causes the second locking member to be displaced inwardly in the radial direction of the shaft main body against a biasing force of the second elastic member, to thereby release engagement of the first and second attachments with the shaft in the axial direction of the shaft.

6. A high pressure tank, comprising:
a liner made of a resin material and including a cylinder portion having a round tubular shape, a first dome portion having a curved shape and disposed at one end part in an axial direction of the cylinder portion, and a second dome portion having a curved shape and disposed at another end part in the axial direction of the cylinder portion;
a first attachment that has an annular shape, is integrally molded with the first dome portion on an axial line of the cylinder portion, and includes a first hole portion penetrating in the axial direction of the cylinder portion;
a second attachment that has an annular shape, is integrally molded with the second dome portion on the axial line of the cylinder portion, and includes a second hole portion penetrating in the axial direction of the cylinder portion and disposed concentrically with the first hole portion;
a first boss having an annular shape and concentrically fixed to the first attachment; and
a second boss having an annular shape and concentrically fixed to the second attachment.
